(19) United States
(12) Patent Application Publication
(10) Pub. No.: US 2002/0095748 A1
(43) Pub. Date: Jul. 25, 2002

(54) Clip

(76) Inventor: Toshimichi Tani, Tokyo (JP)

Correspondence Address: NATH & ASSOCIATES, 1835 K Street, N.W., Suite 750, Washington, DC, 20006, US

(21) Appl. No.: 09/874,114

(22) Filed: Jun. 6, 2001

(30) Foreign Application Priority Data
Jan. 25, 2001 (JP) 2001-017354

(51) Int. Cl. B42F 1/00

(52) U.S. Cl. 24/67.5

(57) ABSTRACT

In a clip, a pair of clip piece portions 1 and 2 bent in the same direction from two bent portions 4-1 and 4-2 of a bent proximal end portion 4 are formed, the two clip piece portions 1 and 2 are kept in contact with each other with a predetermined clamping force, an opening/closing operating portion 3 having an outward curve shape in cross section and projecting returnably to be elastically deformable inwardly and outwardly is formed on one of the two clip piece portions 1 and 2, the opening/closing operating portion 3 is pushed and deformed inwardly so that open ends of the two clip piece portions 1 and 2 are sprung away in a direction to be apart from each other by an elastic spring-back force applied to the opening/closing projection 3, and an opening projection 5 for increasing an opening on the open end sides of the two clip piece portions 1 and 2 is further provided in a portion in the vicinity of the opening/closing operating portion 3 on the open end sides of the two clip piece portions 1 and 2.

### BACKGROUND OF THE INVENTION

The present invention relates to an improvement in an office clip for clipping and binding papers such as memo papers, slips and other documents, a hair clip or a clip for clipping ornamental articles.

Conventionally, an office clip for clipping and binding papers such as memo papers, slips and other documents is known to have a variety of structures and shapes (for example, in Japanese Utility Model Application No. 187467/1983).

In the office clip described in the above-noted Japanese Utility Model Application No. 187467/1983, two cutaway portions are provided in parallel with each other on one side of a pair of clip piece portions bent from a proximal end portion in the same direction, to be directed from the bent proximal end portion to an open end portion to form an intermediate operating portion curved to the outside between the two cutaway portions. When this intermediate operating portion is pushed by a finger tip, the open end side of one clip piece portion having the intermediate operating portion is separated away from the open end side of the other clip piece portion whereby the documents or the like may readily be inserted between the two clip piece portions.

However, although the above-described conventional office clip is adapted to easily insert the documents or the like, after the documents or the like are inserted between the two clip piece portions, the one clip piece portion having the intermediate operating portion has to be brought into contact with the other clip piece portion at a suitable clamping force and brought back to the original condition. In order to return the clip piece portion to the original position where the intermediate operating portion projects outwardly, it is necessary to perform the bending operation to bend the clip as a whole. It is difficult to handle the clip.

There is a fear that the documents or the like inserted between the two clip piece portions would be creased or wrinkled to damage the papers due to the bending operation of the clip as a whole. For this reason, although there is no problem at all in the case where the memo papers are bound together with the office clip, there is a problem that the clip could not be used for formal papers or documents to be sent to the clients. This problem should be solved.

The mechanical strength of the above-described office clip is low due to the fact that the two cutaway portions have to be provided in structure. There is a fear that the clamping force of the two clip piece portions for clipping the papers would become weak and the documents might readily be pulled away between the clip piece portions.

Prints or the like for advertisement are often applied to the surface of this kind of clips. Since the two cutaway portions located on the surface side under the condition that the office clip clips the papers or the like exist in the clip piece portions, the effective advertisement area is decreased.

Beside the office clip having the above-described structure, there is provided an office clip in which a strip-shaped metal plate is bent to form a pair of clip piece portions bent in the same direction from the bent proximal end portion, the open end sides of the two clip piece portions that are in contact with each other with a suitable clamping force are cut so that the edges intersect with each other in a V-shape as viewed in plan view, and the documents or the like is forcibly inserted between the two clip piece portions from the V-shaped intersecting portion. However, this clip has a problem that the documents such as papers would be cut by the intersection portion when the documents are inserted from the edge portions thereof.

The more the number of the papers is increased, the more this issue will be likely to occur. For this reason, it is actually possible to bind only the number of papers much smaller than the designed possible number of the papers to be bound.

### SUMMARY OF THE INVENTION

An object of the present invention is to provide a clip with a high utility, with easy handling and without any fear that a crease or a wrinkle is applied to papers to be bound together or any fear that edge portions of the papers would be cut when the papers are inserted into the clip.

In order to attain this and other objects, according to the present invention, there is provided a clip characterized in that a pair of clip piece portions bent in the same direction from two bent portions of a bent proximal end portion are formed by bending a metal plate, the two clip piece portions are kept in contact with each other on the open end side from a predetermined portion except for the bent proximal end portion side with a predetermined clamping force, an opening/closing operating portion having a slight outward curve shape in cross section and projecting returnably to be elastically deformable inwardly and outwardly is formed on at least one of the two clip piece portions, and the opening/closing operating portion is pushed and deformed inwardly so that open ends of the two clip piece portions are sprung away in a direction to be apart from each other by an elastic spring-back force applied to the opening/closing operating portion.

In the clip according to the present invention, the opening/closing operating portion that projects outwardly is depressed and deformed (elastically or deformed) until the elastic spring-back force is applied to the opening/closing operating portion. The open ends of the two clip piece portions are sprung to be separated away from each other by the elastic spring-back force applied to the opening/closing operating portion. Then, the depressing operation for depressing the opening/closing operating portion is released. The opening/closing operating portion is elastically returned back to the original condition that the opening/closing operating portion projects outwardly, by the elastic spring-back force of the opening/closing operating portion by itself. When the elastic spring-back thereof exceeds a dead point, the open ends of the two clip piece portions are kept in contact with each other with a predetermined clamping force. Accordingly, it is possible to clip and bind the inserted documents without performing the operation such as bending the clip as a whole in order to bring the open ends of the opened clip piece portions back to the original condition as in the conventional clip.

With the clip according to the present invention, it is possible to enhance the handling property without causing, a crease, a wrinkle or the like in the inserted papers and to positively clip and bind the papers without any fear that the edge portions of the papers are cut when the papers are to be inserted.

Another object of the present invention is to provide a further improved clip by which it is possible to firmly clip and bind the papers in a synergy effect of the clamping force and the retaining force without any fear that the bound papers are accidentally pulled apart.

In order to attain this object, in addition to the structure described above, in a clip according to the present invention, an opening projection is provided in the vicinity of the opening/closing operating portion on the open end sides of the two clip piece portions for increasing an opening of the open ends of the two clip piece portions that are sprung apart to be opened by the elastic spring-back force of the opening/closing operating portion when the opening/closing operation portion is depressed and deformed inwardly.

The above-described opening/closing operating portion is provided on one of the clip piece portions and the opening projection is provided on the other clip piece portion whereby the opening projection acts as a fulcrum for spring apart movement of the open end side of the clip piece portions that are sprung and separated from each other when the opening/closing operating portion is depressed and deformed inwardly.

The above-described opening projection is provided in a symmetrical position with respect to the opening/closing operating portion on each side in a widthwise direction of the clip piece portion so as to have such a suitable projecting height that the opening projection does not cause hindrance against the inward deformation of the opening/closing operating portion when the latter is depressed and deformed inwardly.

The projecting direction and the shape of the opening projection is not limited to specific ones. For example, it is preferable to form the opening projection so that the clip to be applied to the edge portions of the papers for clipping and binding the edge portions with the pair of clip piece portions bites and retains the paper surface in the projecting direction that is opposite to the direction in which the clip is pulled apart from the edge portions without any fear that the insertion of the edge portions or the surfaces of the papers into the pair of clip piece portions are hindered. It is preferable to form the projecting shape that is slanted gradually upwardly toward the bent proximal end portion of a rear portion continuous with the pair of clip piece portions.

With such a technical means, under the condition that the pair of clip piece portions are gripped from above and from below, the opening/closing operating portion is depressed and deformed inwardly whereby the open end sides of the two clip piece are sprung apart to be opened by the elastic spring-back force applied to the opening/closing operating portion. At this time, the inward deformation condition of the opening/closing operating portion is remarkable due to the existence of the opening projection. Then, the opening on the open end sides of the two clip piece portions is increased by the spring apart movement about the opening projection as the fulcrum for spring apart. With such a structure, it is possible to insert the edge portions of a possible binding number (for example, about 20) of piled papers between the two clip piece portions that have been opened largely. In other words, it is possible to the edge portions of the papers between the two clip piece portions under the condition that the open end sides of the two clip piece portions are opened widely.

The papers clipped and bound by the clamping force (spring force) of the two clip piece portions are firmly received and bound between the two clip piece portions by the retaining force of the opening projection biting the paper surface. There is no fear that the papers are accidentally pulled apart from between the two clip piece portions. In other words, the clip applied to the edge portions of the papers firmly clips and binds the edge portions of the paper without any fear that the edge portions of the papers are pulled apart, due to the synergy effect of the clamping force of the two clip piece portions and the retaining force of the opening projection.

### BRIEF DESCRIPTION OF THE DRAWINGS

The foregoing and other features of the present invention will become apparent to one skilled in the art to which the present invention relates upon consideration of the present invention with reference to the accompanying drawings, wherein:

FIG. 1 is a perspective view showing a clip according to a first embodiment of the present invention;

FIG. 2 is an enlarged longitudinal sectional view of the clip shown in FIG. 1.

FIG. 3 is a perspective view showing the clip mounting condition that edge portions of papers are inserted to be bound;

FIGS. 4a to 4c are enlarged longitudinal sectional views of the clip shown in FIG. 3,

FIG. 4a showing a condition that an opening/closing operating portion is pushed so that open end portions of two clip piece portions are bounded in a direction to be apart from each other by an elastic spring-back force applied to the opening/closing operating portion,

FIG. 4b showing an intermediate condition after the documents are inserted between the opened two clip piece portions, and

FIG. 4c showing a condition that the edge portions of the documents are brought into contact with a bent proximal end portion of the two clip piece portions and clamped and bound between the two clip piece portions;

FIG. 5 is a perspective view showing a clip according to a second embodiment of the present invention;

FIG. 6 is a perspective view showing a clip according to a third embodiment of the present invention;

FIG. 7 is a longitudinal sectional view showing a clip according to a fourth embodiment of the present invention;

FIG. 8 is a perspective view showing a clip according to a fifth embodiment of the present invention;

FIG. 9 is a plan view of the clip shown in FIG. 8;

FIG. 10 is an enlarged sectional view taken along the line X-X of FIG. 9;

FIGS. 11a to 11c are enlarged longitudinal sectional views of the clip shown in FIG. 10,

FIG. 11a showing a condition that an opening/closing operating portion is pushed so that open end portions of two clip piece portions are sprung in a direction to be apart from each other by an elastic spring-back force applied to the opening/closing operating portion,

FIG. 11b showing an intermediate condition after the documents are inserted between the opened two clip piece portions, and

FIG. 11c showing a condition that the edge portions of the documents are brought into contact with a bent proximal end portion of the two clip piece portions and clamped and bound between the two clip piece portions;

FIG. 12 is an enlarged view of a portion encircled by the circle XII of FIG. 11c;

FIG. 13 is an enlarged cross-sectional view showing a primary part of a clip according to a sixth embodiment of the present invention; and

FIG. 14 is a longitudinal sectional view showing a clip according to a seventh embodiment of the present invention.

### DESCRIPTION OF THE PREFERRED EMBODIMENTS

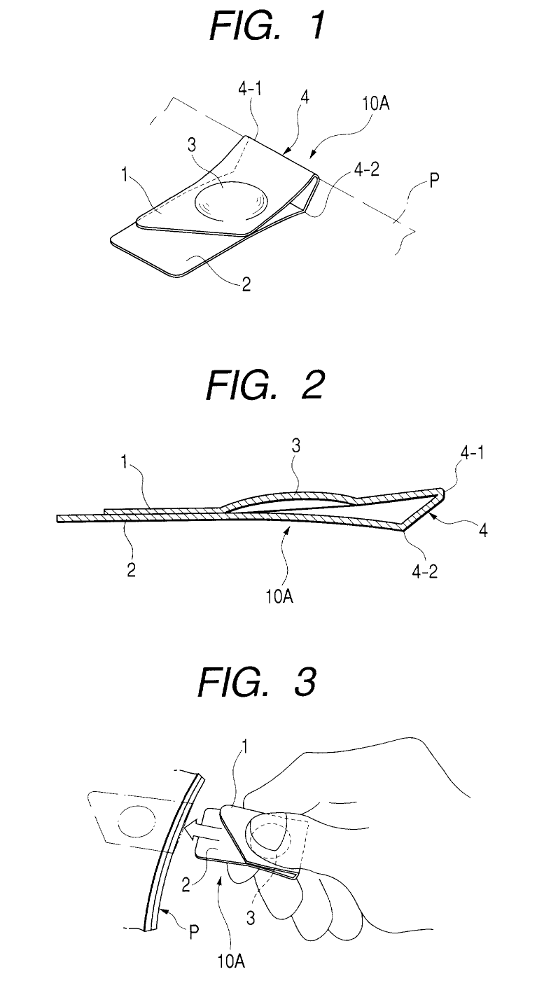

Embodiments of the present invention will now be described with reference to the accompanying drawings. FIGS. 1 to 4 show a clip according to a first embodiment of the present invention. In the clip 10A according to the present invention, a strip-like metal plate that is abundant in elasticity is bent to form a pair of clip piece portions 1 and 2 bent from bent portions 4-1 and 4-2 of its bent proximal end portion 4 in the same direction. Open end sides, from a suitable portion except for the proximal end portion 4, of the two clip piece portions 1 and 2 come into contact with each other with a suitable clamping force. An opening/closing operating portion 3 is formed into a slightly outward curve shape in cross-section on one or both side of the two clip piece portions 1 and 2 and to be projected returnably and elastically deformable outwardly or inwardly.

The two clip piece portions 1 and 2 are made of the strip-like metal plate that is abundant in elasticity with a suitable thickness and are bent in the same direction to form a contact condition with the suitable clamping force with each other to the open ends from the vicinity of the opening/closing operating portion except for the bent proximal end portion 4. Thus, the piled papers P such as documents may be clipped and bound without fail with the clamping force enough to hold them.

The open end of one clip piece portions 1 is set inside of the other clip piece portion 2, and the open end portion is cut obliquely to cause the papers P to be readily inserted (see FIGS. 1 and 3).

The bent proximal end portion 4 continuous with the two clip piece portions 1 and 2 is slanted obliquely backwardly toward the bent portion 4-1 of one clip piece portion 1 from the bent portion 4-2 of the other clip piece portion 2 to reduce its height (width). Thus, the structure does not give a hindrance when the clipped and bound papers P is to be received in a document case. In addition, it is possible to increase a reception amount to the document case.

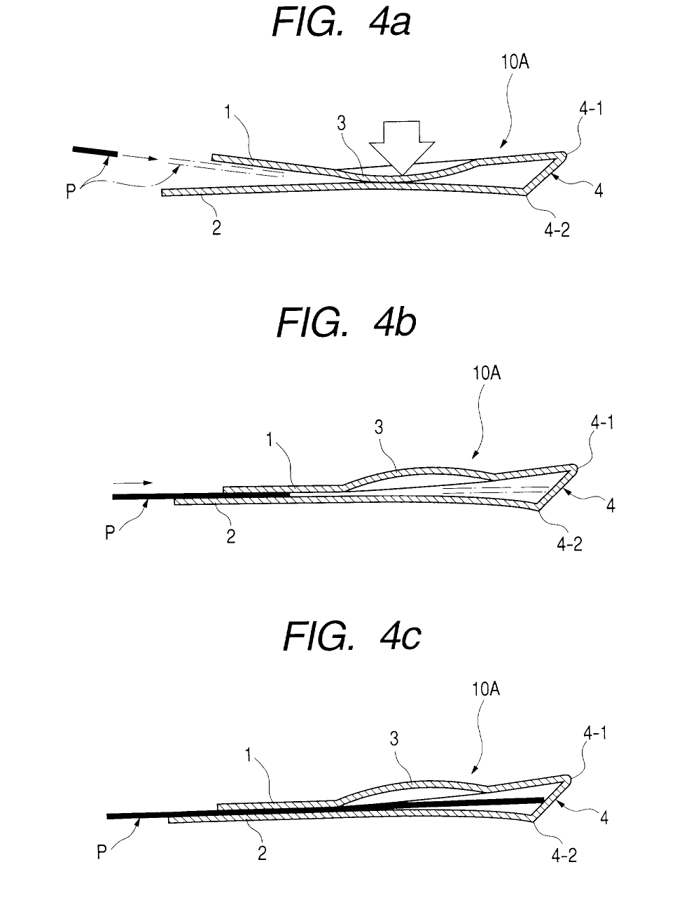

The opening/closing operating portion 3 serves to easily and quickly open the open end sides of the two clip piece portions 1 and 2 closed by a suitable clamping force when the papers P are to be inserted and to close the open end sides that have been opened. The opening/closing operating portion 3 is formed into a slightly outward curve shape in cross-section on the clip piece portion 1 and to be projected returnably and elastically deformable inwardly or outwardly (see FIG. 4).

An example of use of the thus constructed clip 10A will now be described. One clip piece portion 1 having the opening/closing operating portion 3 is held between a thumb and a forefinger with the one clip piece portion 1 being positioned upward and the opening/closing operating portion 3 projecting outwardly is pushed inwardly by the thumb (see FIG. 3). At the moment the opening/closing operating portion 3 is elastically deformed until the elastic spring-back force is applied to the opening/closing operating portion 3, the open end of the clip piece portion 1 is sprung apart to be separated away from the open end of the other clip piece portion 2 (from the condition of FIG. 2 to the condition of FIG. 4a). In other words, the open ends of the two clip piece portions 1 and 2 that have been closed with the suitable clamping force are opened. Thus, the papers P may readily be inserted between the two clip piece portions 1 and 2 (the condition of FIG. 4b). After the papers P have been inserted between the two clip piece portions 1 and 2 to the condition shown in FIG. 4b, when the depressing operation is released, the opening/closing operating portion 3 is elastically returned back to the original condition that it project outwardly by the elastic spring-back force, and at the same time, when the elastic spring-back has reached a dead point, the open end of the clip piece portion 1 is returned back on the open end side of the other clip piece portion 2. Under this condition, the edge portions of the papers P are pushed in until the edge portions are brought into contact with the bent proximal end portion 4 of the two clip piece portions 1 and 2 (the condition indicated by the two-dot-and-dash line in FIG. 4b), whereby it is possible to positively insert and bind the edge portions of the paper P between the two clip portions 1 and 2 without any fear of a crease, a wrinkle or a cut in the edge portions (the condition shown in FIG. 4c). Incidentally, the above-described is only one of examples, and the invention is not limited to this example.

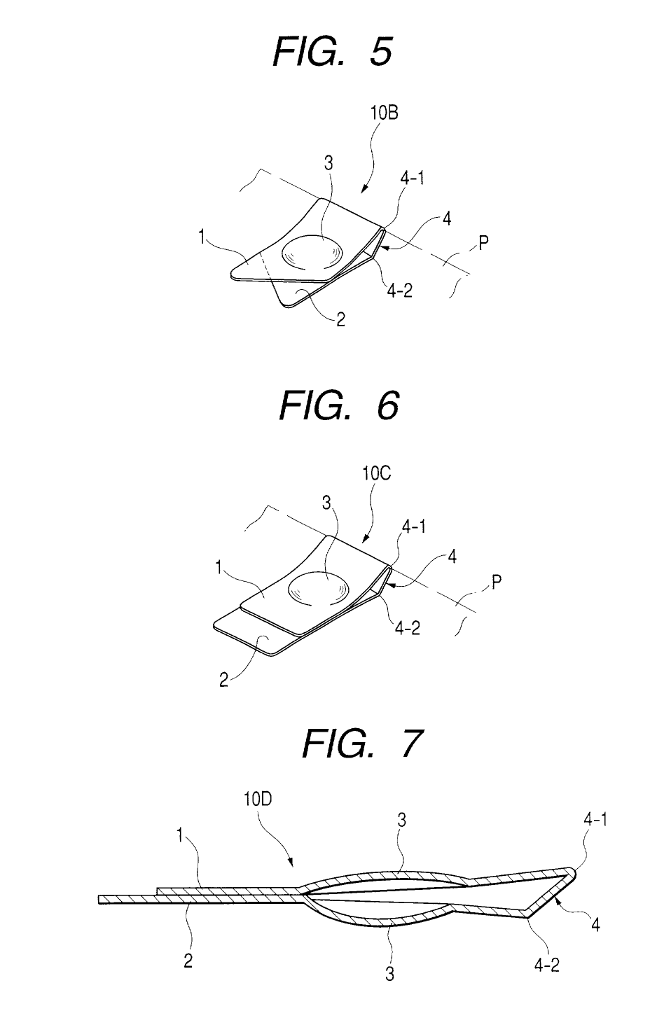

FIGS. 5 and 6 shows clips according to a second embodiment and a third embodiment of the present invention. In a clip 10B shown in FIG. 5, the open ends of the two clip piece portions 1 and 2 of the clip 10A according to the first embodiment are cut obliquely so as to intersect with each other in a substantially V-shape as viewed from above. In a clip 10c shown in FIG. 6, the open end of the one clip piece portion 1 having the opening/closing operating portion 3 is displaced inwardly of the open end of the other clip piece portion 2. In the second and third embodiments, since the basic structure thereof is the same as that of the above-described first embodiment, the same reference numerals are used to indicate the like components or members to omit the duplicated explanation thereof.

In the foregoing first, second and third embodiments, the structure in which the opening/closing operating portion 3 is provided only on the side of the clip piece portion 1 has been described. However, as shown in FIG. 7, in a clip 10D according to a fourth embodiment, it is possible to provide an opening/closing operating portion 3 to the side of the clip piece portion 2 too. The opening/closing operating portions 3 are provided on both of the two clip piece portions 1 and 2, whereby when the opening/closing operating portions 3 are pushed inwardly, an interval between the open ends of the two clip piece portions 1 and 2 which are separated away from each other (the two open ends are opened) is increased in comparison with the case where the opening/closing operating portion 3 is provided only on one side. This is convenient and useful in the case where a large number of papers P are inserted and bound together.

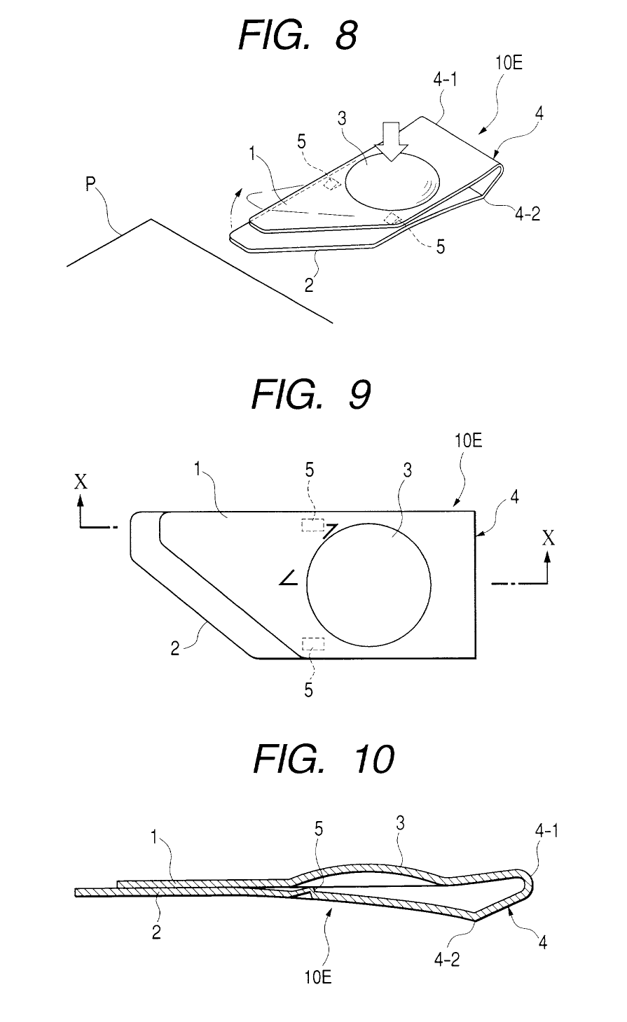

FIGS. 8 to 12 show a clip according to a fifth embodiment of the present invention. In the clip 10E according to the fifth embodiment, a strip-like metal plate that is abundant in elasticity is bent to form a pair of clip piece portions 1 and 2 bent from bent portions 4-1 and 4-2 of its bent proximal end portion 4 in the same direction. Open end sides, from a suitable portion except for the proximal end portion 4, of the two clip piece portions 1 and 2 come into contact with each other with a suitable clamping force (spring force) The possible binding number (for example, about 20) of piled papers P may be clipped and bound with the suitable clamping force.

An opening/closing operating portion 3 is formed into a slight curve shape in cross-section on one or both sides of the two clip piece portions 1 and 2 and to be projected returnably and elastically deformable outwardly or inwardly.

This opening/closing portion 3 is depressed and deformed (elastically deformed) inwardly whereby the open end sides of the two clip piece portions 1 and 2 that are normally closed are sprung apart to be opened by the elastic spring-back force to be applied to the opening/closing operating portion.

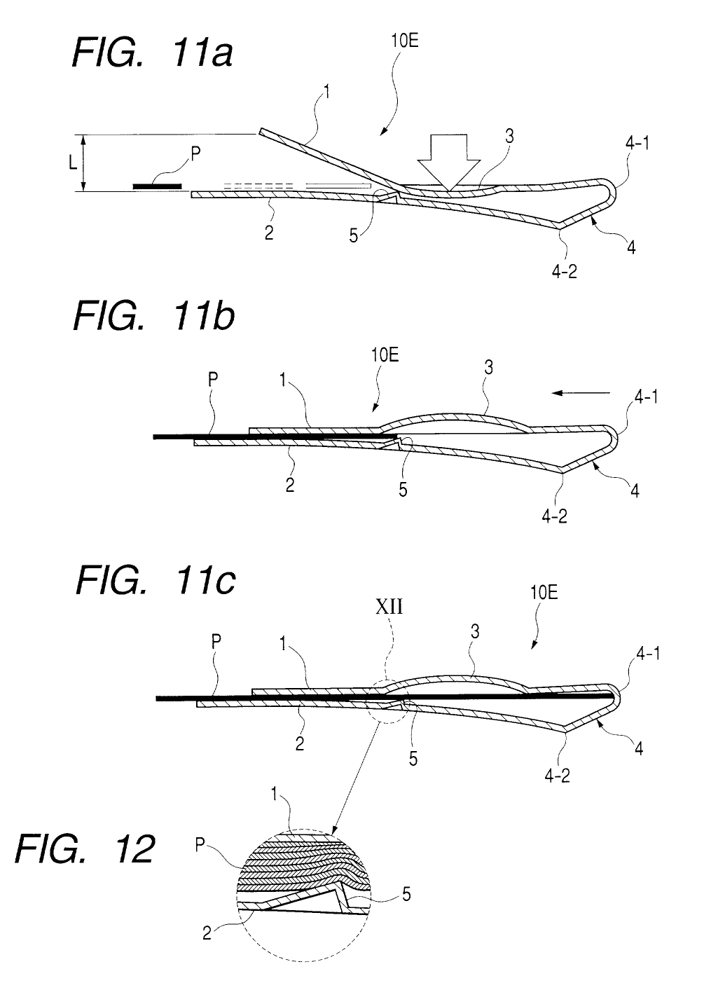

Each opening projection 5 for increasing an opening (opening distance L) on the open end sides of the two clip piece portions 1 and 2 that are sprung apart to be opened by the elastic spring-back force to be applied to the opening/closing operating portion 3 when the opening/closing operating portion 3 is depressed and deformed inwardly, is formed in a portion in the vicinity of the opening/closing operating portion 3 on the open end sides of the two clip piece portions 1 and 2. (See FIG. 11a).

The two clip piece portions 1 and 2 are made of the strip-like metal plate that is abundant in elasticity with a suitable thickness and are bent in the same direction to form a contact condition with the suitable clamping force with each other to the open ends from the vicinity of the opening/closing operating portion except for the bent proximal end portion 4. Thus, the piled papers P such as documents may be clipped and bound without fail with the clamping force enough to hold them.

The open ends of the clip piece portions 1 and 2 are cut obliquely and the open end of one clip piece portion 1 out of the two open ends is made shorter than the open end of the other clip piece portion 2, whereby edge portion of the papers P may be readily inserted (see FIGS. 8 and 9).

The bent proximal end portion 4 continuous with the two clip piece portions 1 and 2 is slanted obliquely backwardly toward the bent portion 4-1 of one clip piece portion 1 from the bent portion 4-2 of the other clip piece portion 2 to reduce its height (width) Thus, the structure is compact and does not give a hindrance when the clipped and bound papers P is to be received in a document case.

The opening/closing operating portion 3 is adapted to open or close the open end sides of the two clip piece portions 1 and 2 when the papers P such as documents are inserted between the two clip piece portions 1 and 2 the open end sides of which are normally closed. The opening/closing operating portion 3 is projected returnably in a shape that the longitudinal section is slightly outward curve and the plan view is a circle on the clip piece portion 1 located on the side of the rear bent proximal end portion 4 (from the condition shown in FIG. 11a to the condition shown in FIG. 11b).

Each opening projection 5 increases the opening between the two clip piece portions 1 and 2 that are separated away from each other by the elastic spring-back force applied to the opening/closing operating portion 3 by the depressing operation inward of the opening/closing operating portion 3. On the other hand, the opening projection 5 serves as a retainer for firmly retaining the papers while biting the paper surface so that the papers P clipped and bound between the two clip piece portions 1 and 2, in particular, the papers P with mirror finish surfaces with slippery paper surfaces do not slip off. The opening projection 5 is formed to project upwardly by bending at symmetrical two positions on both sides in the widthwise direction outside an arc (circumference) of the opening/closing portion 3 located on the side of the open end of the clip piece portion 2 (see FIG. 9). The projections are formed to be slanted gradually upwardly toward the bent proximal end portion 4 continuous with the two piece portions 1 and 2. The opening projections are formed on the side of the clip piece portion 2 with a projecting shape for retaining the paper surfaces of the papers P so that the clipped and bound papers P do not slip off or pulled apart from between the two clip piece portions 1 and 2 (see FIG. 12 which is an enlarged view of FIG. 11c).

An example of use of the thus constructed clip 10E will now be described. One clip piece portion 1 having the opening/closing operating portion 3 is held between a thumb and a forefinger with the one clip piece portion 1 being positioned upwardly and the opening/closing operating portion 3 projecting outwardly is pushed inwardly by the thumb (see FIG. 3). Then, where the opening/closing operating portion 3 is elastically deformed to the state where the elastic spring-back force is applied to the opening/closing operating portion 3, the open end of the clip piece portion 1 is sprung apart to be separated away from the open end of the other clip piece portion 2. The open end sides of the two clip piece portions 1 and 2 that have been closed with the suitable clamping force are opened (from the condition shown in FIG. 10 to the condition FIG. 11a).

At this time, the open end side of the clip piece portion 2 is sprung and separated away from the open end of the clip piece portion 1 by using the opening projections 5 as a fulcrum. As a result, the open end sides of the two clip piece portions 1 and 2 are opened largely. Thus, it is possible to easily and smoothly insert, between the two clip piece portions 1 and 2, not only the papers P composed of several documents but also the possible binding number (for example, about 20) of the papers P (from the condition shown in FIG. 11a to the condition shown in FIG. 11b).

After the papers P have been inserted between the two clip piece portions 1 and 2 to the condition shown in FIG. 11b, when the depressing operation is released, the opening/closing operating portion 3 is elastically returned back to the original condition that it projects outwardly, by its own elastic spring-back force, and at the same time, when the elastic spring-back has reached a dead point, the open end of the clip piece portion 1 is returned back on the open end side of the other clip piece portion 2. Under this condition, the edge portions of the papers P are pushed in until the edge portions are brought into contact with the bent proximal end portion 4 of the two clip piece portions 1 and 2 whereby it is possible to positively insert and bind the edge portions of the paper P between the two clip piece portion 1 and 2 without any fear of a crease, a wrinkle or a cut in the edge portions. The opening projections 5 bite and retain the paper surfaces of the papers P clipped and closed between the two clip pieces portions 1 and 2 by the clamping force of the two clip piece portions 1 and 2 whereby the papers P are firmly received so that the papers P are not accidentally slipped off or pulled apart from between the two clip piece portions 1 and 2 (the condition shown in FIG. 11c).

The papers P are firmly clipped and bound between the two clip piece portions 1 and 2 so that the papers are not accidentally slipped off or pulled apart from between the two clip piece portions 1 and 2 by an synergy effect of the clamping force of the two clip piece portions 1 and 2 and the retaining force of the opening projections 5.

Incidentally, the above-described is only one of examples, and the invention is not limited to the example.

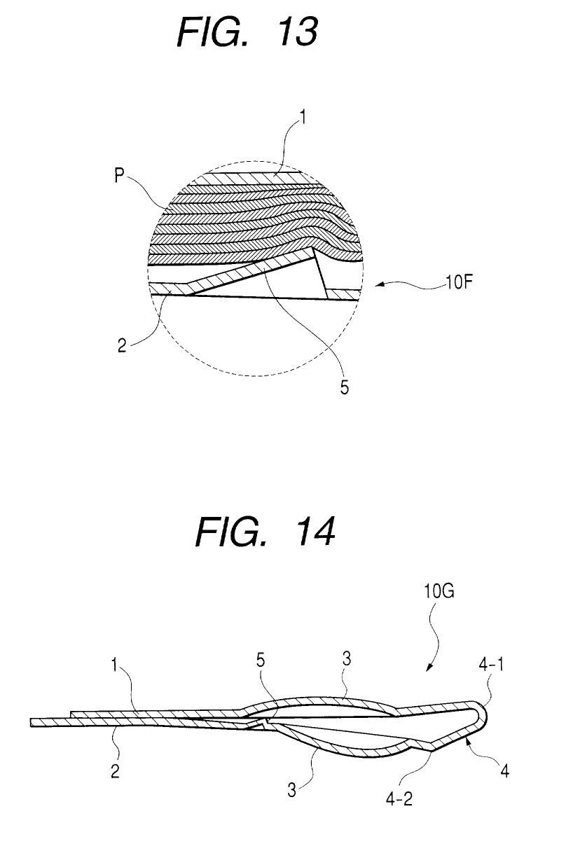

FIG. 13 shows a clip according to a sixth embodiment of the invention. In the clip 10F according to the sixth embodiment, a slit is formed partially when each opening projection 5 is to be formed by bending on the clip piece portion 2 in the clip 10E according to the fifth embodiment, so that its projecting form is slanted gradually upwardly toward the bent proximal end portion 4 continuous with the two clip piece portions 1 and 2.

In the sixth embodiment, since the basic structure thereof is the same as that of the above-described fifth embodiment, the same reference numerals are used to indicate the like components or members to omit the duplicated explanation thereof.

In the foregoing fifth embodiment, the structure in which the opening/closing operating portion 3 is provided only on the side of the clip piece portion 1 has been described. However, in a clip 10G according to a seventh embodiment, as shown in FIG. 14, it is possible to also provide an opening/closing operating portion 3 to the side of the clip piece portion 2. The projection form or the height of the opening projection 5 may be selected as desired but it is preferable that the opening projection may be formed in a way not to damage the paper face. The opening/closing projection may be formed to extend over width of the clip piece portion 2 and may be formed in two or more locations.

What is claimed is:

1. A clip characterized in that a pair of clip piece portions bent in the same direction from two bent portions of a bent proximal end portion are formed, the two clip piece portions are kept in contact with each other with a predetermined clamping force, an opening/closing operating portion having a slight outward curve shape in cross section and projecting returnably to be elastically deformable inwardly and outwardly is formed on at least one of the two clip piece portions, and the opening/closing operating portion is pushed and deformed inwardly so that open ends of the two clip piece portions are sprung away in a direction to be apart from each other by an elastic spring-back force applied to the opening/closing operating portion.

2. The clip according to claim 1, further characterized in that an open end of one clip piece portion out of the two clip piece portions is located inside of an open end of the other clip piece portion and the open end of the one clip piece portion is cut obliquely.

3. The clip according to claim 1, further characterized in that the open ends of the two clip piece portions are cut obliquely to intersect with each other in a V-shape as viewed from above.

4. The clip according to claim 1, further characterized in that an open end of the one clip piece portion having the opening/closing operating portion is located inside of an opening end of the other clip piece portion.

5. The clip according to claim 1, further characterized in that the opening/closing operating projection is formed in each of the two clip piece portions.

6. The clip according to claim 1, further characterized in that an opening projection for increasing an opening on the open end sides of the two clip piece portions is further provided in a portion in the vicinity of the opening/closing operating portion on the open end sides of the two clip piece portions.

7. The clip according to claim 6, further characterized in that the opening projection is formed in a symmetrical position with respect to the opening/closing operating portion in a widthwise direction of the clip piece portion on each side with a predetermined projecting height, and under the condition that papers are clipped and bound between the two clip piece portions, the opening projection has a projecting form directing in such a direction that the papers are retained in their surface and prevented from being slipped off or pulled apart.

8. The clip according to claim 6, further characterized in that an open end of one clip piece portion out of the two clip piece portions is located inside of an open end of the other clip piece portion and the open end of the one clip piece portion is cut obliquely.

9. The clip according to claim 6, further characterized in that a slit is formed in the projecting portion of the opening projection.

10. The clip according to claim 6, further characterized in that the opening/closing operating portion is formed in each of the two clip piece portions.
